(19) United States
(12) Patent Application Publication
(10) Pub. No.: US 2017/0284607 A1
(43) Pub. Date: Oct. 5, 2017

(54) OMNIDIRECTIONAL LED LAMP

(71) Applicant: Yung Pun CHENG, Hong Kong (CN)

(72) Inventor: Yung Pun CHENG, Hong Kong (CN)

(21) Appl. No.: 15/473,235

(22) Filed: Mar. 29, 2017

(30) Foreign Application Priority Data
Mar. 30, 2016 (CN) 201610194489.X

(51) Int. Cl. F21K 9/232; F21V 3/04; F21V 29/83; F21V 17/10; F21K 9/235; F21K 9/238; F21V 23/06

(52) U.S. Cl. CPC F21K 9/232; F21K 9/238; F21V 3/0436; F21V 23/06; F21V 17/101; F21K 9/235; F21V 29/83; F21Y 2115/10

(57) ABSTRACT

An omnidirectional LED lamp comprises a light transmission bulb shell, several curved LED modules, a circuit board, and an interface board that connects to LED modules and lamp base. The LED chips are arranged and mounted on the LED module boards so that a uniform light beam with more than a 320 degree wide angle and high rear light flux can be achieved.

### CROSS-REFERENCE TO RELATED APPLICATION

The present application claims priority to Chinese Patent Application No. 201610194489.X, entitled “Omnidirectional LED Lamp,” filed on Mar. 30, 2016, the entire contents of which are hereby incorporated by reference for all purposes

### FIELD OF INVENTION

The present invention relates to LED lamp technology, and particular, to an LED light bulb.

### BACKGROUND OF INVENTION

Incandescent lamps have been banned in a lot of western countries and the florescent lamps are not environmentally friendly, and often provide comparative low color index. In order to reduce waste and use the existing bulb interface, LED light bulbs using the existing bulb interface was developed. LED light bulb being used for interior lighting is getting more popular nowadays. Due to quite a large amount of heat, which is generated by the LED chips, a conventional LED light bulb comprises a heat sink, a radiation fin set and an insulated bulb base. Waste heat produced during bulb operation is transferred to the heat sink and radiated away via the radiation fin set.

With regard to the A-19 or similar Globe shape LED light bulb for interior lighting, the basic requirements on its luminous intensity distribution and luminance include that the light-emitting of the lamp should be omnidirectional, the luminous intensity distribution should be as uniform as possible, and the luminous flux of areas above and below the bulb should reach a set value to avoid the unevenness of light. In order to regulate the production of LED light bulb, Energy Star issued a standard of LED lighting which prescribes the luminous intensity distribution of omnidirectional LED lamp. It is prescribed in the standard that omnidirectional light bulbs shall have an even distribution of luminous intensity within 0 to 135 degree zone (vertical axially symmetrical). Luminous intensity within this zone shall not differ from the mean luminous intensity for the entire 0 to 135 degree zone by more than 20%. At least 5% of the total flux (lumens) must be emitted in the 135 to 180 degree zone. This means in the zone within 270 degree below the bulb, the luminous intensity should be large and even and in the zone within 90 degree above the bulb, the luminous intensity flux should not be too small.

Due to LED chip source is always being mounted on a heat conduction surface, the maximum beam angle of a LED that can be achieved is 180 degrees, and the half intensity angle is around 140 degrees. The existing LED light bulbs consist of mounted groups of LED chips on a plane surface, and therefore the beam angle of the bulb cannot be too wide. Some of the LED bulbs use special shapes in the outer cover lens to make the bulbs have a wider beam angle, but this cannot achieve the Energy Star's even luminous intensity requirements. The Chinese patent CN201589090 disclosed “a light bulb” which may realize large-emitting angles. However, for it's complicated structure, and because a heat sink at the lower part of the bulb is required, it is difficult to be manufactured. The heat sink at the lower part of the bulb body also blocks light beam and therefore a wide beam angle cannot be achieved.

The technical problem is to provide an omnidirectional LED light bulb with a simple structure, conventional installation, good heat dissipation and even light distribution.

To solve the above problem, provided is an Omnidirectional LED lamp, comprising a light transmission bulb shell, several curved LED modules, which also act as the heat sink, a circuit board, and an interface board that connects LED modules and lamp base. The LED chips are arranged on the LED module boards so that uniform light beam has a 320 degree or more wide beam angle with high rear light intensity flux. The bulb structure has a heat sink which does not block any light intensity from the LED chips. All LED chips are mounted on metal curved plates with a good conductive property. The LEDs can be arranged on the upper part of the metal plate and leaves the lower part of the metal plate to act as a heat sink, which directs the heat away that is generated from the LED chip. The shape of the LED module (the metal plate with mounted LED chips) are made as an elongated S shape so that the light beam of the LED chips on the LED module provides a good and even light intensity.

According to one aspect of the invention, an omnidirectional LED light bulb comprises a lamp base, an electronic driver board, an interface board, at least 3 or more LED modules, a lower plastic lamp shell and an upper plastic lamp shell, wherein the interface board has slots so that the LED module can be fitted into the slots, wherein the interface board has a slot for connecting the electronic driver board on it, the interface board has electrical conduction traces build on its surface so that the DC electric power which is generated from the electronic driver board 3 can be supply to the LED modules via the interface board.

Optionally, the upper and lower plastic lamp shells are joined together by glue or ultrasonic weld.

Optionally, the LED electronic driver circuit is integrated in the interface board.

Optionally, the lower plastic lamp shell has ventilation holes near the lamp base, and the lamp case is a screw base.

Optionally, the lower plastic lamp shell has no ventilation holes for bulbs which has 5 watt or lower electrical consumption power.

In the present inven the lower part of the LED module can be treated as a heat sink to direct heat away from LED chips. The electronic driver board is positioned at the lower part of the bulb and some of it is actually inside the metal screw base which is far away from the heat source and LED chips, this ensures a more stable operating environment for the electronic driver board. Therefore, a more stable, high efficiency LED bulb with a true omnidirectional light source can be achieved.

### BRIEF DESCRIPTION OF THE DRAWINGS

FIG. 1 is a schematic structure diagram according to an embodiment of the present invention;

FIG. 2 is an exploded view of an LED lamp in accordance with the present invention;

FIG. 3(a) is a top view of an LED light bulb according to the embodiment of the present invention;

FIG. 3(b) is a top view of an LED light bulb according to another embodiment of the present invention;

FIG. 4 is the oblique view of an LED module.

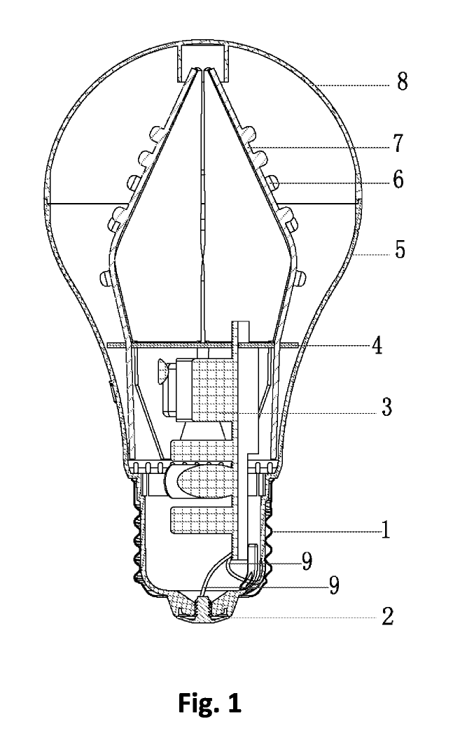

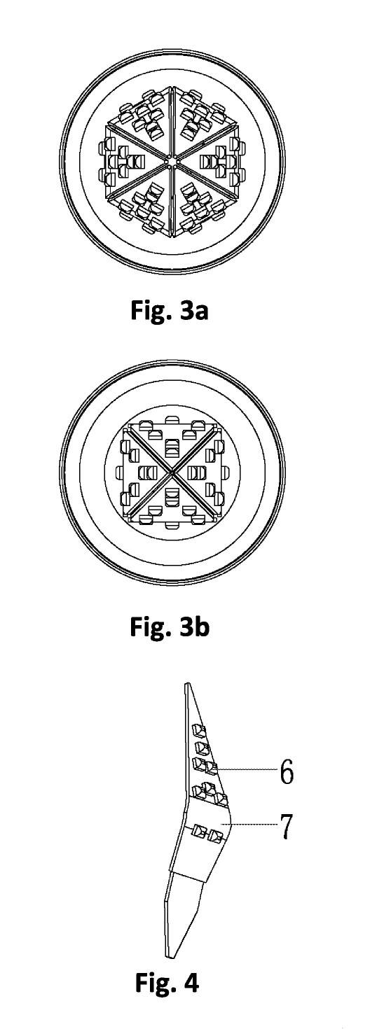

FIGS. 1-4 are shown drawn approximately to scale. However, other relative dimensions may be used if desired.

### EMBODIMENTS OF THE INVENTION

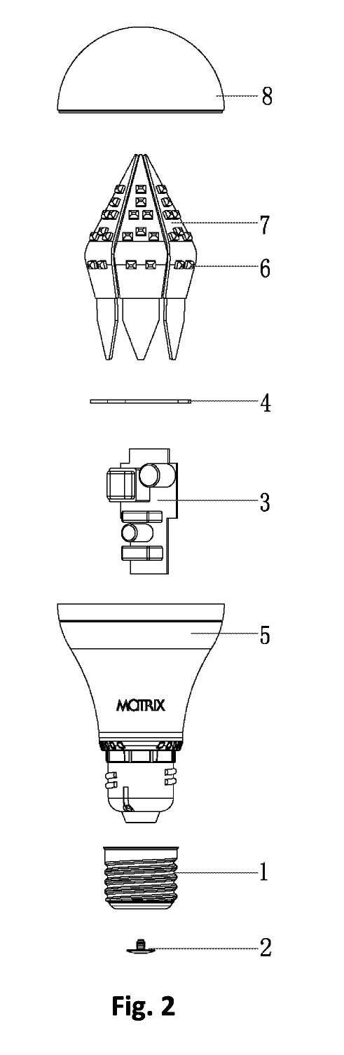

As shown in FIG. 1 and FIG. 2, the present embodiment includes a screw lamp base 1, a positive terminal lamp base 2, an electronic driver board 3 with two wires 9 connect to the lamp base 1 and 2, an interface connection board 4, a lower outer lamp shell 5, LED module 7 with LED chips 6, and an upper outer lamp shell 8. The lamp base 1 is a E26 or E27 lamp base which is tightly connected with the lower outer lamp shell 5. The lower lamp shell 5 is made of highly light transmitting material with has a screw thread base so that the metal lamp base can be screwed into the lamp shell 5 tightly. The electronic driver board 3 is mounted perpendicular to the interface board 4. The electricity supply to the electronic driver board is made via wires 9 to the screw lamp base 1 and the Live terminal 2. The interface board 4 has conduction traces and slots on it so that the lower part of LED modules 7 can be fitted into the slots and therefore the positioning of all LED modules can be firmly placed into the desired positions. Electrical conduction traces on LED modules 7 and the interface board 4 can be soldered together at the junction of the LED modules and the interface board. Similar connection is made for the connectivity between the Electronic driver board 3 and the interface board 4. Electricity supply which is generated from the electronic driver board 3 can now flow from the electronic driver board 3 through the interface board 4 to the LED modules 7. The LED modules board 7 is an aluminum circuit board which can be bended and have LED chips mounted on the upper surface of the them. The LED modules can be bended to the required angle and shape so that wide light beam angle can be achieved. The upper outer lamp shell 8 can be joined to the lower outer lamp shell 5 by glue or by ultrasonic weld.

As shown in FIGS. 3(a), 3(b) and 4, 3 to 6 pieces of the LED modules shall be used for a bulb. The number of LED module used would depend on what light intensity needs to be achieved. An interface board has electrical conduction traces and is used to connect all the LED modules and the electronic driver board together, so that the electricity from the driver board can be distributed to all the LED modules easily. The interface is also serves to hold all LED modules in the correct position. If a larger size bulb is made and the interface board can be bigger with more room, the electronic LED driver board can be integrated into the interface board to simplify the manufacturing process. The bulb shell is made by high light transparent material in a bulb shape. Ventilation holes are located at the lower bottom of the bulb, near the bulb screw base. Ventilation holes are not needed for bulbs with power consumption of 5 W or less. The electronic driver board has an electronic circuit which is connected to the metal bulb base, which supplies the main AC voltage which is required to provide the required DC voltage to the LED modules.

What is claimed is:

1. An omnidirectional LED light bulb comprising a lamp base 1, an electronic driver board 3, an interface board 4, at least 3 or more LED modules 7, a lower plastic lamp shell 5 and an upper plastic lamp shell 8, wherein the interface board 4 has slots so that the LED module 7 can be fitted into the slots, wherein the interface board 4 has a slot for connecting the electronic driver board 3 on it, the interface board 4 has electrical conduction traces build on its surface so that the DC electric power which is generated from the electronic driver board 3 can be supply to the LED modules 7 via the interface board 4.

2. The omnidirectional LED light bulb according to claim 1, wherein the upper and lower plastic lamp shells are joined together by glue or ultrasonic weld.

3. The omnidirectional LED light bulb according to claim 1, wherein the LED electronic driver circuit is integrated in the interface board 4.

4. The omnidirectional LED light bulb according to claim 1, wherein the lower plastic lamp shell 5 has ventilation holes near the lamp base 1, and the lamp case 1 is a screw base.

5. The omnidirectional LED light bulb according to claim 1, wherein the lower plastic lamp shell 5 has no ventilation holes for bulbs which has 5 watt or lower electrical consumption power.
